(19) United States
(12) Patent Application Publication
(10) Pub. No.: US 2024/0106756 A1
(43) Pub. Date: Mar. 28, 2024

(54) IN-HARDWARE CONFIGURATION OF RULES INDICATING HOW TO PROCESS PACKETS RECEIVED BY A DEVICE

(71) Applicant: Mellanox Technologies, Ltd., Yokneam (IL)

(72) Inventors: Roni BAR YANAI, Yokneam (IL); Itai GEFFEN, Yokneam (IL); Ori KAM, Yokneam (IL)

(73) Assignee: Mellanox Technologies, Ltd., Yokneam (IL)

(21) Appl. No.: 17/954,450

(22) Filed: Sep. 28, 2022

(51) Int. Cl. H04L 47/20; H04L 47/24

(52) U.S. Cl. CPC H04L 47/20; H04L 47/24

(57) ABSTRACT

A computing device which may include a programmable hardware device and a microcontroller to, based on a policy and parameters of a packet received by the programmable hardware device, program a rule in the programmable hardware device, the rule indicating how to process the packet.

### FIELD OF THE INVENTION

The present invention relates to the field of computer networking, and more particularly, to hardware acceleration of network computing devices.

### BACKGROUND OF THE INVENTION

Typically, when a data packet is received at a network computing device, the network computing device determines, based on a predefined set of rules configured in hardware of the network computing device, how to process the packet. Unknown packets (e.g. packets for which no rules were configured in hardware of the network computing device) received by the network interface device are typically processed in software according to a predefined policy. Software is further executed to configure new rules (according to the predefined policy) for these unknown packets in the hardware of the computing device. Typically, software-based handling of unknown packets is complex and time consuming.

### SUMMARY OF THE INVENTION

Embodiments of the present invention provide a computing device which may include a programmable hardware device, and a microcontroller to, based on a policy and parameters of a packet received by the programmable hardware device, program a rule in the programmable hardware device, the rule indicating how to process the packet.

Embodiments of the present invention provide a method which may include, using a computing device operating a programable hardware device and a microcontroller: by the microcontroller based on a policy and parameters of a packet received by the programmable hardware device, program a rule in the programmable hardware device, the rule indicating how to process the packet.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1 is a block diagram of an exemplary computing device which may be used with embodiments of the present invention;

FIG. 2 is a block diagram of a network interface controller (MC) for in-hardware programming or configuration of rules indicating how to process packages received at the MC, according to some embodiments of the invention;

FIG. 3 is a flowchart of operations performed by the NIC for in-hardware programming or configuration of rules related to connection tracking functionality of the MC, according to some embodiments of the invention; and

FIG. 4 is a flowchart of a method of in-hardware programming or configuration of rules indicating how to process packages received at a computing device, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the present invention may improve handling of unknown packets by a computing device, e.g. packets for which no rules determining how to process the packets are programed or configured in the computing device.

A computing device used with some embodiments may include a programmable hardware device and a microcontroller.

The programmable hardware device may receive a network packet. The packet may have packet parameters (e.g. packet fields). The packet parameters may include, e.g. a header, a source port number, a destination port number, a protocol in use or any other suitable packet parameter known in the art. Based on the packet parameters, the programmable hardware device may determine whether or not the packet meets (e.g. satisfies a condition of) any rule in a set of rules (e.g. predefined set of rules). Each of the rules in the set of rules may indicate a subset of reference packet parameters indicating how to process the packet (e.g. as described hereinbelow). The set of rules may include a plurality of subsets of reference packet parameters, e.g. one subset of reference packet parameters defined by one of the rules. For example, the packet may meet a rule in the set of rules if that packet has packet parameters that match or correspond to the subset of reference packet parameters defined by that rule. The packet may meet the set of rules if the packet parameters of that packet match or correspond to any subset of reference packet parameters of the plurality of subsets of reference packet parameters. The packet does not meet the set of rules if the packet parameters of that packet do not match or correspond to any of the subsets of reference packet parameters.

If the programmable hardware device determines that the packet meets a rule in the set of rules, the programmable hardware device may process the packet according to the rule: for example an “if” or matching part of the rule may match to a packet, and if the packet is matched, a “then” or action part of the rule may indicate how the packet is to be processed. The processing of the packet may include performing operations such as, e.g. modifying or changing the packet, monitoring the packet, transmitting the packet to a destination port, dropping the packet or any other suitable operation known in the art.

If the programmable hardware device determines that the packet is unknown, e.g. if the packet does not meet the set of rules and/or if no rules are programmed in the programmable hardware device which match to the particular packet, the programmable hardware device may transmit the unknown packet to the microcontroller. The microcontroller may store a policy. The policy may include a plurality of subsets of permitted packet parameters indicating how to process different packets. The policy may be, for example, an access control list (ACL) or any other suitable policy known in the art. The policy may be defined by, for example, an application managing entity. Based on the packet parameters of the unknown packet and the policy, the microcontroller may program, configure or create a new rule in the programmable hardware, wherein the new rule indicates (e.g. in a “then” or action portion which is performed when a rule matches a packet) how to process a packet received by the programable hardware device and having the same (or similar) packet parameters as the previously unknown packet. The processing may, for example, include modifying or changing the packet, monitoring the packet, transmitting the packet to, e.g. a destination port, dropping the packet or any other suitable operation known in the art (e.g. as described herein).

Once the new rule is programmed or configured in the programmable hardware device, the programmable hardware device may receive a packet and determine whether or not the packet meets the new rule and/or any other rule in the set of rules. If the programmable hardware device determines that the packet meets the new rule and/or any other rule in the set of rules, the programmable hardware device may process the packet in the manner defined by the rule(s). If the programmable hardware device determines that the packet does not meet any of the rules in the set of rules, the programmable hardware device may transmit the packet to the microcontroller (e.g. as described above).

In some embodiments, the computing device may be a network interface controller (MC). However, computing devices other that NICs may be configured to carry out embodiments of the present invention. For example, graphical processing units, Field Programmable Gate Arrays (FPGAs), reduced instruction set computers (RISCs), or other suitable computing devices known the art may be configured to carry out the embodiments of the invention.

Embodiments of the present invention may improve handling of unknown packets by the computing device. Particularly, programming or configuring new rules for previously unknown packets (in accordance with the policy) are performed in hardware of the computing device (e.g. by the programable hardware device and the microcontroller). This is in contrast to prior art computing devices in which handling (e.g. processing and definition of new rules) of unknown packets is performed in software, which is more complex and time consuming as compared to handling of unknown packets in hardware.

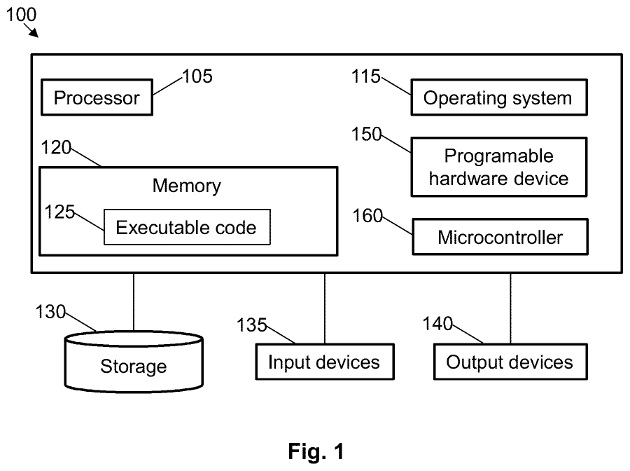

Reference is now made to FIG. 1, which is a block diagram of an exemplary computing device which may be used with embodiments of the present invention.

Computing device 100 may include a processor 105 that may be, for example, a central processing unit processor (CPU), a chip or any suitable computing or computational device, an operating system 115, a memory 120, a storage 130, input devices 135 and output devices 140.

Operating system 115 may be or may include any suitable code segment designed and/or configured to perform tasks involving coordination, scheduling, arbitration, supervising, controlling or otherwise managing operation of computing device 100 (e.g. scheduling execution of programs or any other suitable operation known in the art). Memory 120 may be or may include, for example, a Random Access Memory (RAM), a read only memory (ROM), a Dynamic RANI (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different, memory units. Memory 120 may store for example, instructions to carry out a method (e.g., code 125), and/or data such as user responses, interruptions, etc.

Executable code 125 may be any executable code, e.g., an application, a program, a process, task or script. Executable code 125 may be executed by controller 105 possibly under control of operating system 115. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (MC), a modem, printer or facsimile machine, a universal serial bus (USB) device or external hard drive may be included in input devices 135 and/or output devices 140.

Computing device 100 may include a programable hardware device 150. Programable hardware device 150 may include an array of programmable logic blocks and reprogrammable or reconfigurable interconnects allowing blocks to be interconnected together causing programable hardware device 150 to perform a desired series of logical operations.

Computing device 100 may include a microcontroller 160. Microcontroller 160 may be, for example, an integrated circuit chip including one or more processor cores (e.g. reduced instruction set computer (RISC) based processor cores such as Advanced RISC Machines (ARM), RISC-V or any other suitable processor cores known in the art), memory and programmable input/output peripherals.

In some embodiments, some of the components shown in FIG. 1 may be omitted.

Embodiments of the invention may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

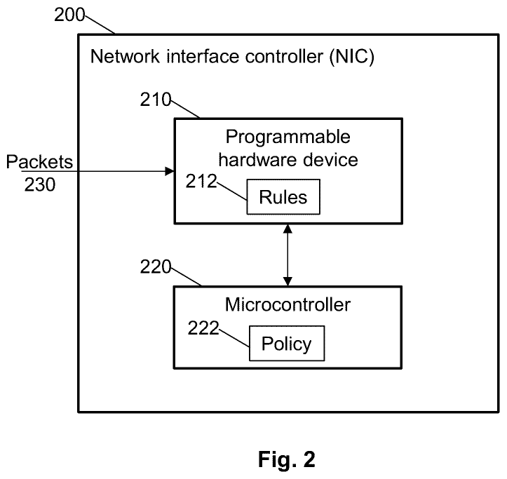

Reference is now made to FIG. 2, which is a block diagram of a network interface controller (NIC) 200 for in-hardware programming or configuration of rules indicating how to process packages received at MC 200, according to some embodiments of the invention. Elements and modules of FIG. 2 may be or may be executed by a computer system such as shown in the example of FIG. 1.

According to some embodiments, NIC 200 may include a programmable hardware device 210 (e.g. such as programmable hardware device 150 described above with respect to FIG. 1) and a microcontroller 220 (e.g. such as microcontroller 160 described above with respect to FIG. 1).

Programable hardware device 210 may receive a plurality of packets 230 (e.g. from a plurality of ports of MC 200). A packet received at programable hardware device 210 may include packet parameters (e.g. packet fields). The packet parameters may include, e.g. a header, a source port number, a destination port number, a protocol in use or any other suitable packet parameter known in the art. Programmable hardware device 210 may determine, based on the packet parameters, whether or not the packet meets or satisfies the conditions of a set 212 of rules (e.g. predefined set of rules). Each of the rules in set 212 of rules may indicate a subset of reference packet parameters indicating how to process the packet. Set 212 of rules may include a plurality of subsets of reference packet parameters, e.g. one subset of reference packet parameters defined by one of the rules. For example, the packet may meet a rule in set 212 of rules if that packet has packet parameters that match or correspond to the subset of reference packet parameters defined by that rule. The packet may meet set 212 of rules if the packet parameters of that packet match or correspond to any subset of reference packet parameters of the plurality of subsets of reference packet parameters defined by set 212 of rules. The packet may not meet set 212 of rules if the packet parameters of that packet do not match or correspond to any of the subsets of reference packet parameters defined by set 212 of rules. Set 212 of rules may be programed or configured in programable hardware device 210. For example, programmable hardware device 210 may be programmed or configured to perform a series of logical operations to determine whether or not the packet parameters conform with the reference packet parameters of set 212 of rules and indicate how to process the packet.

If programmable hardware device 210 determines that the packet meets set 212 of rules, programmable hardware device 210 may process the packet in the manner defined by the rules of set 212. The processing of the packet by programable hardware device 210 may, for example, include modifying or changing the packet, monitoring the packet, transmitting the packet, dropping the packet to a destination port or any other suitable operation known in the art.

If programmable hardware device 210 determines that the packet does not meet set 212 of rules and/or that no rules for the particular packet are programmed or configured in programmable hardware device 210, the packet may not be processed. A packet that does not meet set 212 of rules and/or a packet for which no rules are programmed or configured in programmable hardware device 210 is also referred herein as “unknown packet”. Programmable hardware device 210 may transmit the unknown packet to microcontroller 220. Microcontroller 220 may include or store a policy 222. Policy 222 may, for example, be an access control list (ACL), connection tracking or any other suitable policy known in the art. Policy 222 may include a plurality of subsets of permitted packet parameters indicating how to process different packets. For example, if the packet indicates a source port of X1 and a destination port of Y1, the packet may be transmitted to the destination port. In another example, if the packet indicates a source port of X2, the packet may be dropped. Any other suitable combinations of packet parameters and/or operations are possible. Based on the packet parameters of the unknown packet and policy 222, microcontroller 220 may program or configure a new rule in set 212 of rules in programmable hardware device 210, wherein the new rule indicates how to process a packet received by programable hardware device 210 and having the same (or similar) packet parameters as the previously unknown packet.

Once the new rule is programmed or configured in programmable hardware device 210, programmable hardware device 210 may receive a packet and determine whether or not the packet meets the new rule and/or any other rule in set 212 of rules. If programmable hardware device 210 determines that the packet meets the new rule and/or any other rule in set 212 of rules, programmable hardware device 210 may process the packet in the manner defined by the rule(s) (e.g. as described above). If programmable hardware device 210 determines that the packet does not meet any of the rules in set 212 of rules, programmable hardware device 210 may transmit the packet to microcontroller 220 (e.g. as described above).

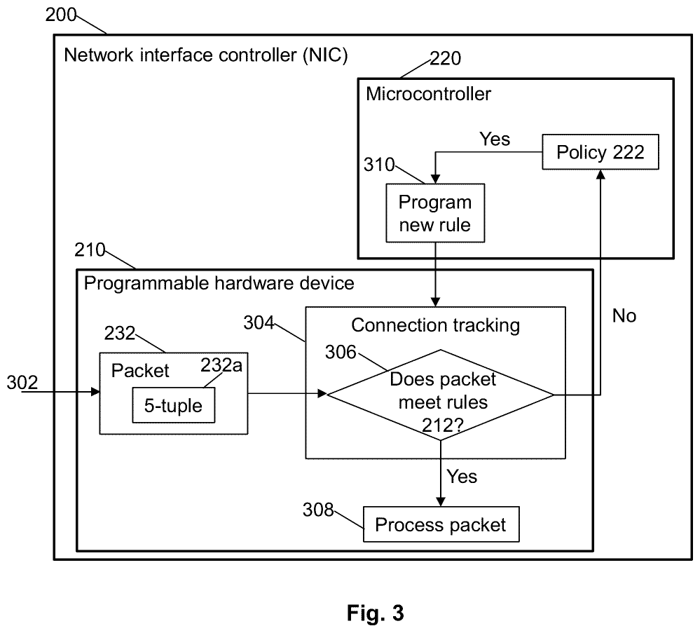

Reference is now made to FIG. 3, which is a flowchart of operations performed by NIC 200 for in-hardware programming or configuration of rules related to connection tracking functionality of NIC 200, according to some embodiments of the invention.

In operation 302, a packet 232 may be received, e.g. by programmable hardware device 210 of MC 200. Packet 232 may have packet parameters 232a that may include, e.g. a 5-tuple referring to five different values that identify Transmission Control Protocol/Internet Protocol (TCP/IP) connection or session.

In operation 304, a connection tracking may be performed by, e.g. programmable hardware device 210, e.g. to maintain state information about a connection in, e.g. memory tables.

In operation 306 (e.g. as part of connection tracking 304), based on packet parameters 232a, it may be determined, e.g. by programable hardware device 210, whether or not packet 232 meets set 212 of rules programmed or configured in programable hardware device 210 (e.g. as described above with respect to FIG. 2).

If it is determined by programable hardware device 210 that packet 232 meets set 212 of rules, in operation 308 programable hardware device 210 may process packet 232 in the way defined by the rules (e.g. packet 232 may be modified, monitored, transmitted, dropped or processed in any other suitable way known in the art as described above with respect to FIG. 2).

If it is determined by programable hardware device 210 that packet 232 does not meet set 212 of rules, packet 232 may be transmitted by programable hardware device 210 to, e.g. microcontroller 220. In operation 310, based on packet parameters 232a and policy 222, a new rule may be programed or configured in programmable hardware device 210 by microcontroller 220 (e.g. as described above with respect to FIG. 2). The new rule may indicate how to process a packet received by programable hardware device 210 and having the same (or similar) packet parameters 232a as packet 232 (e.g. as described above with respect to FIG. 2).

The processing of packet 232a by, e.g., programmable hardware device 210 may, for example, include modifying or changing the packet, monitoring the packet, transmitting the packet to, e.g. a destination port, dropping the packet or any other suitable operation known in the art (e.g. as described above).

The processing of packet 232a by, e.g., programmable hardware device 210 may, for example, include modifying network address information in the IP header of packet 232, e.g. as part of network address translation (NAT) operation.

If a connection defined by packet 232 (or a plurality of packets such as packet 232) remains inactive for more than a specified time duration, microcontroller 220 may program or configure programable hardware device 210 to delete one or more rules (e.g. of set 212 of rules) related to the packet(s) that define the connection.

Computing devices other that MC 200 may be configured to carry out embodiments of the present invention. For example, graphical processing units or any other suitable computing devices known the art may be configured to carry out the embodiments of the invention.

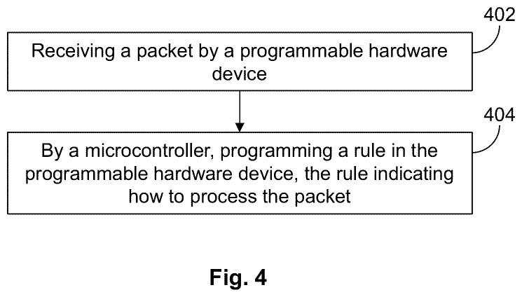

Reference is now made to FIG. 4, which is a flowchart of a method of in-hardware programming or configuration of rules indicating how to process packages received at a computing device, according to some embodiments of the invention. The method may be performed using a computing device, such as the computing devices described with respect to FIGS. 1, 2 and 3, but other systems may be used.

In operation 402, a packet having packet parameters may be received by a programable hardware device of a computing device (e.g. by programable hardware device 210 described above with respect to FIG. 2).

Based on the packet parameters, it may be determined by the programmable hardware device whether or not the packet meets a set of rules (e.g. set 212 of rules programmed or configured in the programmable hardware device, as described above with respect to FIGS. 2 and 3). If it is determined by the programmable hardware device that the packet meets the set of rules, the packet may be processed by, e.g. the programmable hardware device, as described above with respect to FIGS. 2 and 3). Processing the packet may, for example, include modifying the packet, monitoring the packet, transmitting the packet to a port or performing any other suitable operation.

Processing the packet may, for example, include modifying network address information in an Internet Protocol (IP) header of the packet as part of a network address translation (NAT) operation.

If it is determined by the programmable hardware device that the packet is unknown, e.g. that the packet does not meet the set of rules and/or that no rules for the particular packet are programmed or configured in the programmable hardware device, the packet may not be processed. The unknown packet may be transmitted by the programmable hardware device to a microcontroller (e.g. microcontroller 220 described above with respect to FIGS. 2 and 3). Based on the packet parameters of the unknown packet and a policy (e.g. policy 222; as described above with respect to FIGS. 2 and 3), in operation 404 a new rule may be programed or configured in the programmable hardware device by the microcontroller, wherein the new rule may indicate how to process a packet received by the programable hardware device and having the same (or similar) packet parameters as the previously unknown packet.

Once the new rule is programmed or configured in the programmable hardware device, it may be determined by the programmable hardware device whether or not a packet received by the programmable hardware device meets the new rule and/or any other rule in the set of rules. If it is determined by the programmable hardware device that the packet meets the new rule and/or any other rule in the set of rules, the packet may be processed by the programmable hardware device (e.g. as described above). If it is determined the programmable hardware device that the packet does not meet any of the rules in the set of rules, the packet may be transmitted by the programmable hardware device to the microcontroller (e.g. as described above).

If a connection defined by the packet is inactive for more than a specified time duration, the programmable hardware device may be programed, e.g. by the microcontroller, to delete a rule related to the packet.

Embodiments of the present invention may improve handling of unknown packets by the computing device. Particularly, programming or configuring the new rule for previously unknown packets are performed in hardware of the computing device (e.g. by the programable hardware device and the microcontroller). This is in contrast to prior art computing devices in which handling (e.g. processing and definition of new rules) of unknown packets is performed in software, which is more complex and time consuming as compared to handling of unknown packets in hardware.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A computing device comprising:
a programmable hardware device; and
a microcontroller to, based on a policy and parameters of a packet received by the programmable hardware device, program a rule in the programmable hardware device, the rule indicating how to process the packet.

2. The computing device of claim 1, wherein the programmable hardware device is to:
based on the parameters of the packet, determine whether or not the packet meets a rule in a set of rules programmed in the programmable hardware device; and
if it is determined that the packet meets the rule in the set of rules, process the packet as indicated by the rule.

3. The computing device of claim 1, wherein the programmable hardware device is to:
based on the parameters of the packet, determine whether or not the packet meets a rule in a set of rules programmed in the programmable hardware device; and
if it is determined that the packet does not meet any rule in the set of rules, transmit the packet to the microcontroller.

4. The computing device of claim 1, wherein processing the packet comprises at least one of modifying the packet, monitoring the packet and transmitting the packet to a port.

5. The computing device of claim 1, wherein processing the packet comprises modifying network address information in an Internet Protocol (IP) header of the packet as part of a network address translation (NAT) operation.

6. The computing device of claim 1, wherein the microcontroller is to:
if a connection defined by the packet is inactive for more than a specified time duration, program the programmable hardware device to delete a rule related to the packet.

7. The computing device of claim 1, wherein processing the packet comprises dropping the packet.

8. The computing device of claim 1, wherein the computing device is one of a network interface controller (MC), a graphical processing unit (GPU), Field Programmable Gate Array (FPGA) or reduced instruction set computer (RISC).

9. A method comprising, using a computing device operating a programable hardware device and a microcontroller:
by the microcontroller, based on a policy and parameters of a packet received by the programmable hardware device, programming a rule in the programmable hardware device, the rule indicating how to process the packet.

10. The method of claim 9, comprising, by the programmable hardware device:
based on the parameters of the packet, determining whether or not the packet meets a rule in a set of rules programmed in the programmable hardware device; and
if it is determined that the packet meets the rule in the set of rules, processing the packet as indicated by the rule.

11. The method of claim 9, comprising, by the programmable hardware device:
based on the parameters of the packet, determining whether or not the packet meets a rule in a set of rules programmed in the programmable hardware device; and
if it is determined that the packet does not meet any rule in the set of rules, transmitting the packet to the microcontroller.

12. The method of claim 9, wherein processing the packet comprises at least one of modifying the packet, monitoring the packet and transmitting the packet to a port.

13. The method of claim 9, wherein processing the packet comprises modifying network address information in an Internet Protocol (IP) header of the packet as part of a network address translation (NAT) operation.

14. The method of claim 9, comprising:
by the microcontroller, if a connection defined by the packet is inactive for more than a specified time duration, programing the programmable hardware device to delete a rule related to the packet.

15. The method of claim 9, wherein processing the packet comprises dropping the packet.
